(19) United States
(12) Patent Application Publication
(10) Pub. No.: US 2011/0050413 A1
(43) Pub. Date: Mar. 3, 2011

(54) DUAL-WARNING PROTECTOR HAVING MULTIPLE PROTECTIONS

(76) Inventor: Robert WANG, Luch (TW)

(21) Appl. No.: 12/551,731

(22) Filed: Sep. 1, 2009

(51) Int. Cl. G08B 21/00; G08B 5/00

(52) U.S. Cl. 340/540; 340/691.1

(57) ABSTRACT

A dual-warning protector having multiple protections includes a protection circuit, a first alarm circuit and a second alarm circuit. The protection circuit includes two protection modules each having a thermistor, a semiconductor discharge tube, and a voltage dependent resistor. The protector provides multiple protections for the equipment, the circuit and the maintenance personnel, keeping the operating voltage steadily and not interrupting communication.

### BACKGROUND OF THE INVENTION

1. Field of the Invention

The present invention relates to a dual-warning protector having multiple protections.

2. Description of the Prior Art

Generally, there is a protector disposed between a telecommunication cable and a switchboard apparatus for preventing the equipment from being damaged because of a short circuit or a lightning strike. A conventional protector comprises a protection circuit and an alarm circuit. The protection circuit uses a thermistor and a semiconductor discharge tube for protecting it from over voltage or over current. The alarm circuit uses an illuminating member to activate a phototransistor which is adapted to start a light emitting diode to radiate light for providing a warning to remind the maintenance personnel of abnormal circuit. The conventional protector guides the surge to the ground wire via the protection circuit. However, the operating voltage is interrupted, which is unable to proceed to communication, causing an indirect loss. In addition, the conventional protector uses the phototransistor for a light control alarm, which has many shortcomings, such as large size, difficulty in packing, and light leakage or the like. The conventional protector is unable to remind the maintenance personnel of high voltage when the parts in the protector have a breakdown or aging, which may cause an accident because of getting an electric shock. Accordingly, the inventor of the present invention has devoted himself based on his many years of practical experiences to solve this problem.

### SUMMARY OF THE INVENTION

According to the present invention, there is provided a dual-warning protector having multiple protections, disposed between a telecommunication cable and a switchboard apparatus, comprising:

a protection circuit including two protection modules which are identical and disposed on two different signal lines respectively, the protection modules each including a thermistor connected to one of the signal lines in the way of series connection, a fuse connected to the signal line in the way of series connection, a semiconductor discharge tube connected between the signal line and a ground wire, and a voltage dependent resistor connected between the signal line and the ground wire;

a first alarm circuit including two first illuminating modules and a light control alarm module, the two first illuminating modules being respectively connected to the signal lines in the way of parallel connection, the light control alarm module being disposed at a rear end of the protection circuit and connected to the ground wire in the way of series connection, the first illuminating modules each including a first resistor and a first light emitting diode, the light control alarm module including a phototransistor and a third light emitting diode, the phototransistor being disposed close to the first light emitting diode; and

a second alarm circuit including two second illuminating modules which are respectively connected to the signal lines in the way of parallel connection, the second illuminating modules each including a second resistor and a second light emitting diode, the second resistor having a resistance valve much greater than that of the first resistor of the first illuminating module.

Accordingly, when there is a surge, the protection circuit will absorb it for providing a protection effect. With the thermistor, the operating voltage is kept when the protection circuit is acting for ensuring the communication not being interrupted. Besides, when high current passes through, the fuse will be blown to form a broken circuit, achieving a protection for the circuit. Furthermore, when there is high voltage in the protector, the maintenance personnel is able to know it via the second alarm circuit, preventing the maintenance personnel from getting an electric shock.

### BRIEF DESCRIPTION OF THE DRAWINGS

FIG. 1 is a schematic view showing the circuit of a preferred embodiment of the present invention;

FIG. 2 is a side view of a protection module of the present invention; and

FIG. 3 is a front view of the protection module of the present invention.

### DETAILED DESCRIPTION OF THE PREFERRED EMBODIMENTS

Embodiments of the present invention will now be described, by way of example only, with reference to the accompanying drawings.

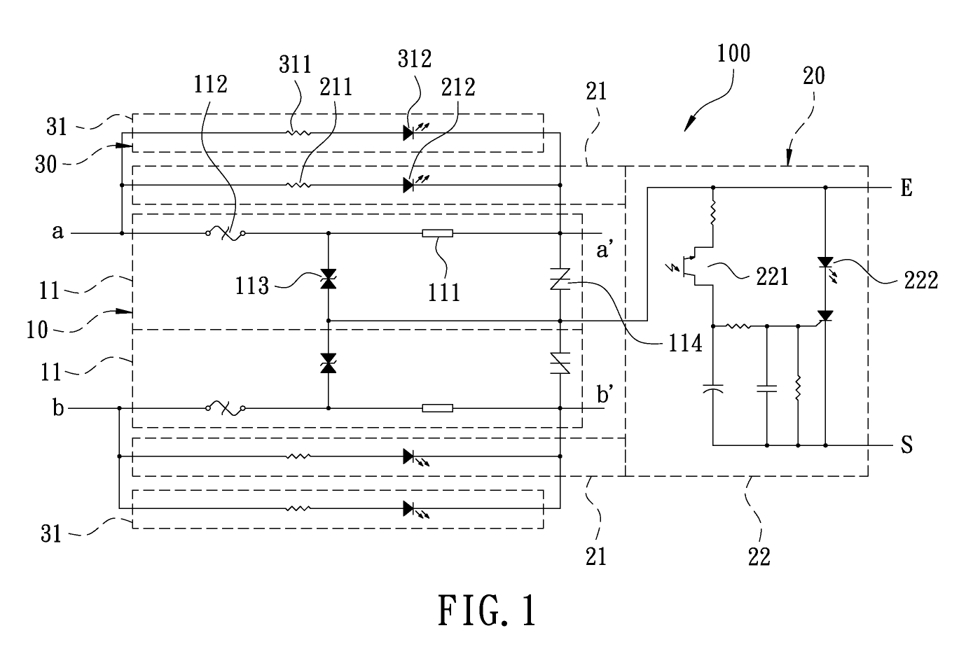

As shown in FIG. 1, a protector 100 according to a preferred embodiment of the present invention is disposed between a telecommunication cable and a switchboard apparatus, and comprises a protection circuit 10, a first alarm circuit 20, and a second alarm circuit 30.

The protection circuit 10 includes two protection modules 11 which are identical and disposed on two different signal lines aa′ and bb′, respectively. The protection module 11 provided on the signal line aa′ is given as an example. The protection module 11 includes a thermistor 111 connected to the signal line aa′ in the way of series connection, a fuse 112 disposed in front of the thermistor 111, a semiconductor discharge tube 113 connected between the signal line aa′ and a ground wire E, and a voltage dependent resistor 114 connected between the signal line aa′ and the ground wire E. The semiconductor discharge tube 113 is located at a front end of the thermistor 111, and the voltage dependent resistor 114 is located at a rear end of the thermistor 111. The starting voltage of the semiconductor discharge tube 113 is greater than that of the voltage dependent resistor 114.

The first alarm circuit 20 includes two first illuminating modules 21 and a light control alarm module 22. The two first illuminating modules 21 are respectively connected to the signal line aa′ and the signal line bb′ in the way of parallel connection. The light control alarm module 22 is disposed at a rear end of the protection circuit 10 and connected to the ground wire E in the way of series connection. Each of the first illuminating modules 21 includes a first resistor 211 and a first light emitting diode 212. The light control alarm module 22 includes a phototransistor 221 and a third light emitting diode 222. The phototransistor 221 is disposed close to the first light emitting diode 212. The second alarm circuit 30 includes two second illuminating modules 31 which are respectively connected to the signal line aa′ and the signal line bb′ in the way of parallel connection. Each of the second illuminating modules 31 includes a second resistor 311 and a second light emitting diode 312. The resistance valve of the second resistor 311 is much greater than that of the first resistor 211.

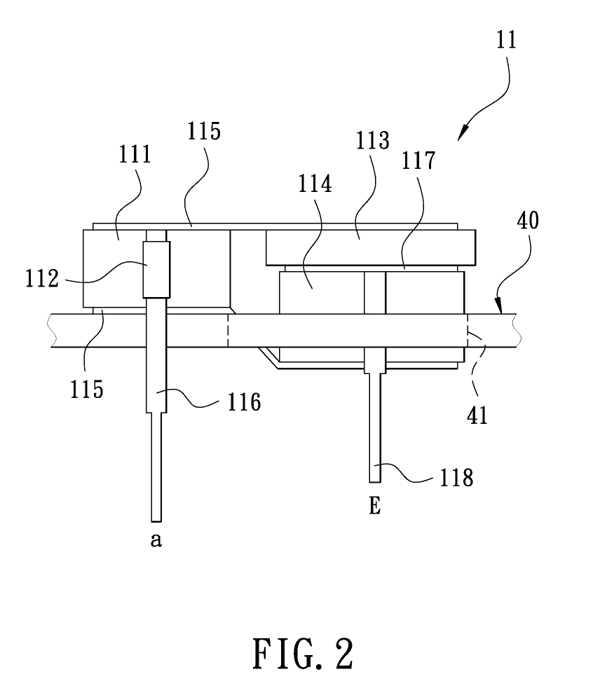

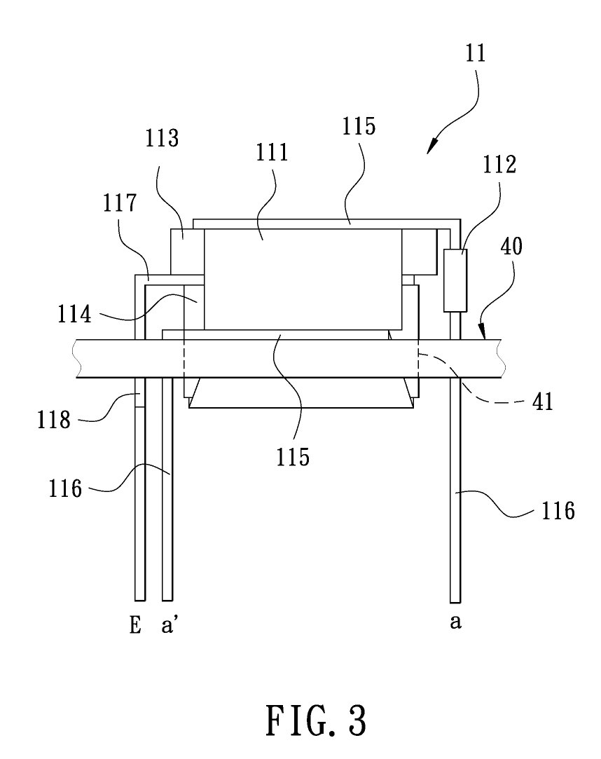

FIG. 2 is a side view of the protection module. FIG. 3 is a front view of the protection module. The protection modules 11 are disposed on a circuit board 40. The thermistor 111 has a top and a bottom connected with first copper plates 115. The first copper plates 115 have connecting legs 116 which are connected with the signal line aa′ so that the thermistor 111 is connected to the signal line aa′ in the way of series connection. The connecting leg 116 at the front end of the thermistor 111 is connected with the fuse 112 in the way of series connection. In this embodiment, the fuse 12 is a thermal fuse. The first copper plates 115 extend a specific distance in the same direction to form a space therebetween for stacking up the semiconductor discharge tube 113 and the voltage dependent resistor 114 in sequence. A second copper plate 117 is provided between the semiconductor discharge tube 113 and the voltage dependent resistor 114. The second copper plate 117 has a connecting leg 118 which is connected with the ground wire E. Accordingly, the semiconductor discharge tube 113 and the voltage dependent resistor 114 are connected between the signal line aa′ and the ground wire E. Besides, the circuit board 40 is formed with a through hole 41 corresponding in position to the voltage dependent resistor 114 for insertion of the voltage dependent resistor 114 so as to decrease the height of the protection module 11.

Referring to FIG. 1, under a normal status, the telecommunication cable and the switchboard apparatus has an operating voltage (48V) so that the semiconductor discharge tube 113 is in an open circuit status. The resistance valves of the first resistor 211 and the second resistor 311 are much greater than that of the thermistor 111 so that the communication current of the telecommunication cable are transmitted from a,a′ ends to b, b′ ends of the signal lines aa′, bb′, respectively, through the thermistor 111 into the switchboard apparatus.

During communication, if there is a surge and the voltage of the surge is greater than the starting voltage of the semiconductor discharge tube 113, the semiconductor discharge tube 113 will form a closed circuit and guide most of the current to the ground wire E. The resistance valve of the thermistor 111 will rise quickly so that partial current is forced to go through the first illuminating module 21 of the first alarm circuit 20 to start the first light emitting diodes 212 to radiate light. Meanwhile, the phototransistor 221 of the light control alarm module 22 is shone to trigger the third light emitting diode 222 to radiate light for warning the maintenance personnel of abnormal circuit. Because the resistance of the second resistor 311 of the second alarm circuit 30 is greater than those of the first resistor 211 and the thermistor 111, only minimal current passes therethrough, which is unable to start the second light emitting diode 312. The current passing through the thermistor 111 will be absorbed by the voltage dependent resistor 114 to keep the voltage (50V) which is slightly greater than the operating voltage (48V) of the telecommunication cable and the switchboard apparatus. Therefore, the communication current will not be interrupted, proceeding to do communication.

When the voltage of the surge is less than the starting voltage of the semiconductor discharge tube 113, the semiconductor discharge tube 113 will keep in an open status, without any action. At this time, the voltage of the thermistor 111 rises quickly so that partial current is forced to pass through the first illuminating module 21 of the first alarm circuit 20 to start the first light emitting diodes 212 to radiate light so as to trigger the light control alarm module 22 for warning the maintenance personnel of abnormal circuit. Meanwhile, the current passing through the thermistor 111 will be absorbed quickly by the voltage dependent resistor 114 and then be radiated in the form of heat to keep the voltage (50V) so that the communication current will not be interrupted. Because the resistance of the second resistor 311 of the second alarm circuit 30 is much greater than those of the first resistor 211 and the thermistor 111, only minimal current passes therethrough, which is unable to start the second light emitting diode 312. Thereby, the protector 100 provides multiple protection functions, including protecting the equipment, keeping the operating voltage, and not interrupting communication.

The parts in the protector 100 may become aging. In this embodiment, the semiconductor discharge tube 113 becoming aging is given as an example. When current greater than the operating voltage of the semiconductor discharge tube 113 is inputted from the “a” end, the semiconductor discharge tube 231 fails to form a closed circuit. Thus, the resistance valve of the thermistor 111 rises quickly to form high current, which will blow the fuse 112. The current will be forced to go toward the first alarm circuit 20 and the second alarm circuit 30 for starting the third light emitting diode 222 and the second light emitting diode 312 to radiate light such that the maintenance personnel is able to know that the protector 100 has high voltage, preventing the maintenance personnel from getting an electric shock.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A dual-warning protector having multiple protections, disposed between a telecommunication cable and a switchboard apparatus, comprising:
a protection circuit including two protection modules which are identical and disposed on two different signal lines respectively, the protection modules each including a thermistor connected to one of the signal lines in the way of series connection, a fuse connected to the signal line in the way of series connection, a semiconductor discharge tube connected between the signal line and a ground wire, and a voltage dependent resistor connected between the signal line and the ground wire;
a first alarm circuit including two first illuminating modules and a light control alarm module, the two first illuminating modules being respectively connected to the signal lines in the way of parallel connection, the light control alarm module being disposed at a rear end of the protection circuit and connected to the ground wire in the way of series connection, the first illuminating modules each including a first resistor and a first light emitting diode, the light control alarm module including a phototransistor and a third light emitting diode, the phototransistor being disposed close to the first light emitting diode; and
a second alarm circuit including two second illuminating modules which are respectively connected to the signal lines in the way of parallel connection, the second illuminating modules each including a second resistor and a second light emitting diode, the second resistor having a resistance valve much greater than that of the first resistor of the first illuminating module.

2. The dual-warning protector having multiple protections as claimed in claim 1, wherein the fuse is a thermal fuse disposed in front of the thermistor.

3. The dual-warning protector having multiple protections as claimed in claim 1, wherein the semiconductor discharge tube is located at a front end of the thermistor and the voltage dependent resistor is located at a rear end of the thermistor.

4. The dual-warning protector having multiple protections as claimed in claim 1, wherein the protection modules are disposed on a circuit board, the thermistor having a top and a bottom connected with first copper plates, the first copper plates having connecting legs connected with the signal line, the connecting leg at a front end of the thermistor being connected with the fuse in the way of series connection, the first copper plates extending a specific distance in a direction to form a space therebetween for stacking up the semiconductor discharge tube and the voltage dependent resistor in sequence, a second copper plate being provided between the semiconductor discharge tube and the voltage dependent resistor, the second copper plate having a connecting leg connected with the ground wire.

5. The dual-warning protector having multiple protections as claimed in claim 4, wherein the circuit board is formed with a through hole corresponding in position to the voltage dependent resistor for insertion of the voltage dependent resistor.
